(19) United States
(12) Patent Application Publication
(10) Pub. No.: US 2026/0214036 A1
(43) Pub. Date: Jul. 23, 2026

(54) Packet Re-Transmisson for Reliable Unordered Delivery

(71) Applicant: Cisco Technology, Inc., San Jose, CA (US)

(72) Inventors: Srinivas Gangam, San Jose, CA (US); Ayan Banerjee, San Jose, CA (US); Ramesh Sivakolundu, San Jose, CA (US)

(21) Appl. No.: 19/035,710

(22) Filed: Jan. 23, 2025

(51) Int. Cl. H04L 43/0829; H04L 47/34

(52) U.S. Cl. CPC H04L 43/0829; H04L 47/34

(57) ABSTRACT

Devices, networks, systems, methods, and processes for detecting packet loss in a digital communication network are provided herein. The digital communication network may include at least one source device. The source device may transmit a set of packets of a flow that has the same Entropy Value (EV) and unique sequence numbers. The source device may further receive an acknowledgment for a delivered packet of the set of packets, where the acknowledgment can include the EV and a sequence number of the delivered packet. Furthermore, the source device may detect, based on the EV and the sequence number, whether a packet loss corresponding to the EV has occurred in the flow. Accordingly, the packet loss may be detected without timing outs or receiving negative acknowledgments. Therefore, the dependency time outs or negative acknowledgments may be suppressed. Consequently, the delays in re-transmission of lost packets may be reduced.

The present disclosure relates to digital communication. More particularly, the present disclosure relates to packet loss detection and re-transmission in digital communication networks that utilize reliable unordered delivery.

### BACKGROUND

Digital communication networks serve as the foundation for modern data-intensive applications by enabling seamless interaction between multiple interconnected devices. In High-Performance Computing (HPC) environments, such as Artificial Intelligence (AI) learning and large-scale simulations, minimizing communication latency is a key requirement for achieving optimal performance. To address latency, many conventional techniques utilize unordered delivery, leveraging the hashing capabilities of network switches to balance the load across multiple paths. This load balancing may assist in reducing potential bottlenecks and enhancing overall throughput in HPC environments.

However, unordered packet delivery can present challenges that affect reliability. For example, as packets of the same flow traverse different network paths, varying conditions such as congestion and intermittent link failures can still lead to packet loss. Managing transmission under these circumstances can be complex, especially in networks that require consistent performance.

Conventional methods typically address packet loss by employing timing out or Negative Acknowledgments (NAKs) to detect and re-transmit lost packets. While these methods can ensure eventual delivery, they might introduce significant delays. The reliance on waiting for timing out or NAKs often makes these solutions less feasible for latency-sensitive applications in HPC environments.

### SUMMARY OF THE DISCLOSURE

Systems and methods for detecting packet loss in digital communication networks that facilitate unordered delivery, and re-transmission of lost packets for reliable communication in accordance with embodiments of the disclosure are described herein. In one aspect of the present disclosure, a source device is provided. The source device comprises a processor and a memory communicatively coupled to the processor. The memory comprises a packet transmission logic. The packet transmission logic is configured to transmit a first set of packets of a flow, where the first set of packets has a same first Entropy Value (EV) and unique sequence numbers. Further, the packet transmission logic is configured to receive an acknowledgment including the first EV and a sequence number of a delivered packet of the first set of packets. Furthermore, the packet transmission logic is configured to detect, based on the first EV and the sequence number in the acknowledgment, whether a packet loss corresponding to the first EV has occurred in the flow.

In many embodiments, the packet transmission logic is further configured to transmit a second set of packets of the flow, where the second set of packets has a same second EV and unique sequence numbers.

In many additional embodiments, prior to transmitting the first set of packets and the second set of packets, the packet transmission logic is further configured to assign the first EV to the first set of packets and the second EV to the second set of packets.

In many further embodiments, the first EV is assigned to the first set of packets and the second EV is assigned to the second set of packets based on one or more weights associated with the first EV and the second EV.

In further embodiments, the first EV is assigned to the first set of packets and the second EV is assigned to the second set of packets based on a round-robin scheme.

In still further embodiments, the packet transmission logic is further configured to maintain a mapping database for a plurality of EVs including the first EV and the second EV. In still yet further embodiments, the packet transmission logic is configured to record in the mapping database, in a transmission order of the first set of packets, the unique sequence numbers of the first set of packets in association with the first EV, and in a transmission order of the second set of packets, the unique sequence numbers of the second set of packets in association with the second EV.

In further additional embodiments, recording the unique sequence numbers of the first set of packets in the mapping database comprises storing a reduced version of a corresponding unique sequence number in association with the first EV.

In additional embodiments, to detect whether the packet loss has occurred in the flow, the packet transmission logic is further configured to perform a look-up in the mapping database based on the first EV and the sequence number of the delivered packet. Further, the packet transmission logic is configured to determine, based on the look-up, whether the mapping database indicates presence of one or more unacknowledged packets of the first set of packets that are transmitted prior to the delivered packet.

In still additional embodiments, the packet loss is detected in a case where the mapping database indicates the presence of the one or more unacknowledged packets that are transmitted prior to the delivered packet.

In still yet additional embodiments, the packet transmission logic is further configured to re-transmit the one or more unacknowledged packets in a case where the packet loss is detected.

In many additional embodiments, the packet transmission logic is further configured to remove a set of sequence numbers of the one or more unacknowledged packets from the mapping database based on the re-transmission of the one or more unacknowledged packets. Further, the packet transmission logic is configured to record, in a transmission order, a set of new sequence numbers of the re-transmitted one or more unacknowledged packets in the mapping database in association with the first EV.

In more embodiments, the packet transmission logic is further configured to re-transmit the one or more unacknowledged packets without timing out.

In still more embodiments, the packet transmission logic is further configured to re-transmit the one or more unacknowledged packets, independent of a negative acknowledgment for the one or more unacknowledged packets.

In yet more embodiments, the packet loss is detected to be absent in a case where the mapping database indicates absence of the one or more unacknowledged packets of the first set of packets that are transmitted prior to the delivered packet.

In still yet more embodiments, the packet transmission logic is further configured to remove the sequence number of the delivered packet from the mapping database upon detection of whether the packet loss corresponding to the first EV has occurred in the flow.

In some more embodiments, the first set of packets having the first EV comprises non-consecutive packets of the flow.

In another aspect of the present disclosure, a source device is provided. The source device comprises a processor, a memory communicatively coupled to the processor, and a packet transmission logic. The packet transmission logic is configured to transmit a set of packets of a flow, where the set of packets has a same EV and unique sequence numbers. Further, the packet transmission logic is configured to receive an acknowledgment including the EV and a sequence number of a delivered packet of the set of packets. Furthermore, the packet transmission logic is configured to identify, based on the EV and the sequence number in the acknowledgment, one or more unacknowledged packets in the set of packets that are transmitted prior to the delivered packet. Furthermore, the packet transmission logic is configured to re-transmit the identified one or more unacknowledged packets.

In a number of embodiments, the packet transmission logic is further configured to re-transmit the one or more unacknowledged packets without timing out or receiving a negative acknowledgment for the one or more unacknowledged packets.

In yet another aspect of the present disclosure, a packet transmission method is provided. The packet transmission method comprises transmitting a set of packets of a flow, where the set of packets has a same EV and unique sequence numbers. Further, the packet transmission method comprises receiving an acknowledgment including the EV and a sequence number of a delivered packet of the set of packets. Furthermore, the packet transmission method comprises detecting, based on the EV and the sequence number in the acknowledgment, whether a packet loss corresponding to the EV has occurred.

In a variety of embodiments, the packet transmission method further comprises re-transmitting one or more packets of the set of packets that are associated with the packet loss, without timing out or receiving a negative acknowledgment for the one or more packets.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is a conceptual block diagram for packet loss detection and re-transmission in accordance with various embodiments of the disclosure;

FIG. 3 is a conceptual block diagram for updating a mapping database in event of packet loss in accordance with various embodiments of the disclosure;

FIG. 4 is a flowchart depicting a process for packet re-transmission in accordance with various embodiments of the disclosure;

FIG. 5 is a flowchart depicting another process for packet re-transmission in accordance with various embodiments of the disclosure;

FIG. 6 is a flowchart depicting a process for recording sequence numbers in accordance with various embodiments of the disclosure;

FIG. 7 is a flowchart depicting a process for removing the sequence numbers in accordance with various embodiments of the disclosure;

FIG. 8 is a flowchart depicting a process for sorting one or more packets in accordance with various embodiments of the disclosure; and

FIG. 9 is a conceptual block diagram of a device suitable for configuration with a packet transmission logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for packet loss detection and re-transmission in digital communication networks that utilize reliable unordered delivery. To minimize communication latency for High-Performance Computing (HPC) applications, many conventional systems facilitate the transmission of packets in an unordered manner, leveraging the hashing capabilities of network switches to balance the load across multiple paths. However, unordered packet delivery can present challenges that affect reliability. For example, as packets traverse different network paths, varying conditions such as congestion and intermittent link failures can still lead to packet loss. To address such packet loss, conventional systems rely on time-outs or negative acknowledgments to detect and re-transmit lost packets. While these systems ensure eventual delivery, they might introduce significant delays due to waiting for timing out or negative acknowledgments. To this end, in a variety of embodiments, a packet transmission logic may be provided to optimize re-transmission of lost packets such that waiting for time-outs or negative acknowledgments is suppressed.

In a number of embodiments, the packet transmission logic may be implemented within a digital communication network that utilizes reliable unordered delivery. In various examples, the digital communication network may include a source device, at least one network device (e.g., a switch, an access point, or the like), and a destination device. In numerous examples, the source device may implement the packet transmission logic.

In various embodiments, the source device may be configured to generate a flow comprising a plurality of packets for at least one application associated with the destination device. In various examples, each packet of the plurality of packets may include a payload and at least one header. In an example, the payload may include data corresponding to the application. The header may include essential information about the corresponding packet, for example, source and destination addresses, a sequence number (also referred to as a Packet Sequence Number “PSN”), a protocol number, error-checking information, or the like. In many examples, the source and destination addresses may include a source Internet Protocol (IP) address, a destination IP address, a source port number, and a destination port number. In various embodiments, the sequence number may be a unique identifier assigned to each packet of the plurality of packets. Further, each packet of the plurality of packets may be assigned with a sequence number in such a way that the assigned sequence number is greater than the sequence number of a previous packet of the plurality of packets. Thus, sequence numbers are monotonically increasing numbers assigned to the plurality of packets for maintaining order of transmission.

In many embodiments, the source device may be configured to assign one of a plurality of Entropy Values (EVs) to each outgoing packet of the flow. In an example, the EV, included in a packet header of a packet, may serve as an identifier used by the network device to select a forwarding path for the packet. In other words, if the network device and the destination device are communicatively coupled via a plurality of paths, each path may be uniquely identified by an EV of the plurality of EVs. Thus, by varying the EVs, the source device may ensure that the plurality of packets are evenly distributed across multiple paths.

In a number of embodiments, the source device may assign the plurality of EVs to the plurality of packets based on a round-robin scheme. For example, if the plurality of EVs includes a first EV (EV=1) and a second EV (EV=2), the source device may assign the first and second EVs in a cyclic manner. Thus, a first packet may be assigned EV=1, a second packet EV=2, a third packet EV=1, and so on. In other words, after the last EV in the sequence of the plurality of EVs is reached, the EVs wrap around and start again from the beginning.

In a variety of embodiments, the source device may be configured to determine weights for the plurality of EVs, and the assignment of an EV to a packet may be based on these determined weights. In various examples, the weights may be determined based on congestion information associated with the plurality of EVs. For example, if the plurality of EVs includes the first EV (EV=1) having a weight of 0.7 and the second EV (EV=2) having a weight of 0.3, the source device may assign the first EV to 70% packets of the flow and the second EV to the remaining 30% packets. Since the plurality of EVs are assigned as per a round-robin scheme or determined weights, the same EV may be assigned to non-consecutive packets of the flow.

In various embodiments, packets that have the same EV may share the same n-tuple combination. For example, if a first set of packets of the plurality of packets has the first EV and a second set of packets of the plurality of packets has the second EV, the first set of packets may share the same first n-tuple combination and the second set of packets may share the same second n-tuple combination. In an example, n-tuple combination may correspond to a 4-tuple combination (e.g., the source and destination IP addresses and the source and destination port numbers), a 5-tuple combination (e.g., the source and destination IP addresses, the source and destination port numbers, and the protocol number), or the like. In more embodiments, mapping between EVs and specific n-tuple fields may be predetermined. In a non-limiting example, it is assumed that the plurality of EVs include two EVs, such as the first EV and the second EV.

In further embodiments, upon assigning the first and second EVs, the source device may be configured to transmit the first and second sets of packets to the destination device via the switch. In an example, the source device may transmit the first and second sets of packets in an order that follows the sequence numbers of the first and second sets of packets. In still further embodiments, the source device may maintain a mapping database for the plurality of EVs. In various embodiments, the mapping database may correspond to a tabular database, where each row of the mapping database corresponds to a respective EV of the plurality of EVs and includes sequence numbers of all unacknowledged packets that are assigned the respective EV. For example, the mapping database may include first and second rows. The first row may correspond to the first EV and store the sequence numbers of all unacknowledged packets that are assigned with the first EV. Likewise, the second row may correspond to the second EV and store the sequence numbers of all unacknowledged packets that are assigned with the second EV. The sequence numbers for each EV may be recorded in a transmission order of corresponding packets. For example, upon transmitting the first set of packets, the source device may be configured to record, in the mapping database, the sequence numbers of the first set of packets in association with the first EV, following the transmission order of the first set of packets. Thus, the sequence number of the latest transmitted packet may recorded at head of the first row. Likewise, upon transmitting the second set of packets, the source device may be configured to record, in the mapping database, the sequence number of the second set of packets in association with the second EV, following the transmission order.

In further additional embodiments, when a packet transmitted by the source device is successfully delivered to the destination device, the destination device may transmit an acknowledgment (ACK) for the delivered packet back to the source device via the switch. The acknowledgment may include a sequence number and a target EV of the delivered packet, confirming successful receipt at the destination device. For example, the target EV may correspond to one of the first EV or the second EV. Instead of waiting for time-outs or negative acknowledgments, the source device may utilize such received acknowledgments and the mapping database to detect whether a packet loss has occurred in the flow or not.

In a non-limiting example, it is assumed that the target EV is the first EV. Upon receiving the acknowledgment, the source device may be configured to detect, based on the first EV and the sequence number included in the acknowledgment, whether a packet loss corresponding to the first EV has occurred in the flow. In order to detect whether the packet loss corresponding to the first EV has occurred, the source device may be configured to perform a look-up in the mapping database based on the first EV and the sequence number of the delivered packet. In many examples, performing the look-up may include identifying, in the mapping database, a row that corresponds to the first EV. Performing the look-up may further include determining, in the identified row, whether one or more sequence numbers exist preceding the sequence number of the delivered packet. In an example, if the one or more sequence numbers exist preceding the sequence number of the delivered packet in the identified row, the source device may determine that the mapping database indicates presence of one or more packets that were transmitted prior to the delivered packet and are still unacknowledged. Conversely, if no sequence number exists preceding the sequence number of the delivered packet in the identified row, the source device may determine that the mapping database indicates absence of any unacknowledged packet that was transmitted prior to the delivered packet. In other words, considering that the latest transmitted packet is recorded at head of a row, if the sequence number of the delivered packet is not at a tail of the identified row, the mapping database indicates presence of one or more unacknowledged packets that have the first EV and are transmitted prior to the delivered packet. A similar look-up may be performed upon receiving an acknowledgment including the second EV.

In still yet additional embodiments, if the mapping database indicates the absence of the one or more unacknowledged packets, the source device may be configured to detect that the packet loss corresponding to the first EV has not occurred. Upon detecting that the packet loss corresponding to the first EV has not occurred, the source device may be configured to remove, from the mapping database, the sequence number of the delivered packet.

In many additional embodiments, if the mapping database indicates the presence of the one or more unacknowledged packets, the source device may be configured to detect that the packet loss corresponding to the first EV has occurred. Upon detecting that the packet loss corresponding to the first EV has occurred, the source device may be configured to identify the one or more unacknowledged packets based on the one or more sequence numbers that exist preceding the sequence number of the delivered packet. Upon identifying the one or more unacknowledged packets, the source device may be configured to re-transmit the one or more unacknowledged packets. Accordingly, the source device may re-transmit the one or more unacknowledged packets without timing out or receiving a negative acknowledgment for the one or more unacknowledged packets.

In more embodiments, upon re-transmitting the one or more unacknowledged packets, the source device may be configured to remove a set of sequence numbers of the one or more unacknowledged packets from the mapping database. In an example, the source device may remove, as the set of sequence numbers, the one or more sequence numbers that exist preceding the sequence number of the delivered packet. For example, the one or more sequence numbers that exist preceding the sequence number of the delivered packet may be removed from the identified row of the mapping database. Upon removing the one or more sequence numbers, the source device also remove the sequence number of the delivered packet from the identified row of the mapping database. Upon removing the sequence number of the delivered packet, the source device record, in the mapping database, a set of new sequence numbers of the re-transmitted one or more unacknowledged packets in association with the first EV, following the transmission (or re-transmission) order. For example, the set of new sequence numbers may be recorded at the head of the identified row as per the transmission order.

Advantageously, the reception of the acknowledgment for the delivered packet may trigger the source device to determine, based on the target EV and the sequence number included in the acknowledgment, whether the packet loss corresponding to the target EV has occurred in the flow. The detection of the packet loss corresponding to the target EV may trigger the source device to re-transmit one or more lost packets corresponding to the target EV. Accordingly, the source device may re-transmit the lost packets without timing out or receiving a negative acknowledgment for the lost packets. Therefore, the source device may suppress or reduce the waiting time for timing out and/or negative acknowledgments. Consequently, the source device may reduce the delays in the re-transmission of the lost packets as compared to conventional reliable unordered delivery systems that rely on timing out and/or negative acknowledgments for packet retransmission.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

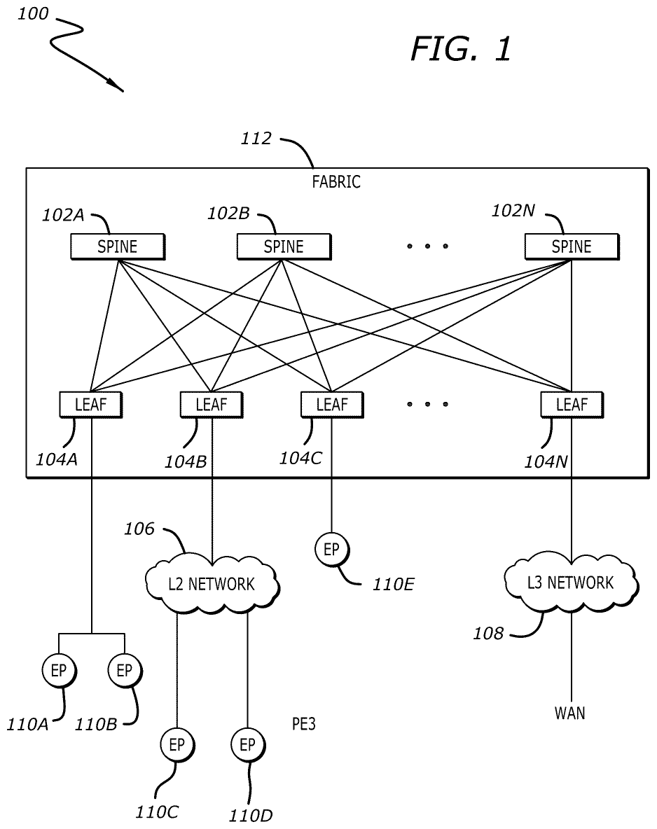

Referring to FIG. 1, a schematic block diagram of an example architecture 100 for a network fabric 112 in accordance with various embodiments of the disclosure is shown. The network fabric 112 may include spine switches 102A, 102B, . . . 102N (collectively “102”) connected to leaf switches 104A, 104B, 104C, . . . 104N (collectively “104”) in the network fabric 112. As those skilled in the art will recognize, the network fabric 112 can refer to a high-speed, high-bandwidth interconnect system that enables multiple devices to communicate with each other efficiently and reliably. It is a network topology that is designed to provide a flexible and scalable infrastructure for data center, cloud environments, and other network elements. In a variety of embodiments, the network fabric 112 may correspond to an Ultra Ethernet Consortium (UEC) enabled network fabric.

Various embodiments described herein can include a leaf-spine architecture comprising a plurality of spine switches and leaf switches. In an example, the leaf-spine architecture may include the spine switches 102 and the leaf switches 104. The spine switches 102 can be Layer 3(L3 ) switches in the network fabric 112. However, in some cases, the spine switches 102 can also, or otherwise, perform Layer 2(L2 ) functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In certain embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of the endpoint address identifier to locator mapping in a mapping database on behalf of leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102i, where subscript “i” indicates that this operation may occur at any spine switch 102A to 102N, the spine switch 102i can first check if the destination locator address is a proxy address. If so, the spine switch 102i can perform the proxy function as previously mentioned. If not, the spine switch 102i can look up the locator in its forwarding table and forward the packet accordingly.

In a number of embodiments, one or more spine switches 102 can connect to one or more leaf switches 104 within the network fabric 112. The leaf switches 104 can include access ports (or non-fabric ports) and fabric ports. Fabric ports can provide uplinks to the spine switches 102, while access ports can provide connectivity for devices, hosts, endpoints, Virtual Machines (VMs), or external networks to the network fabric 112.

In more embodiments, leaf switches 104 can reside at the edge of the network fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulate packets, enforce ingress or egress policies, etc. Moreover, the leaf switches 104 can contain virtual switching functionalities, such as a Virtual Extensible Local Area Network (VXLAN) Tunnel Endpoint (VTEP) function. To this end, the leaf switches 104 can connect the network fabric 112 to an overlay network.

In further embodiments, network connectivity in the network fabric 112 can flow through the leaf switches 104. Here, the leaf switches 104 can provide servers, resources, endpoints, external networks, or VMs access to the network fabric 112, and can connect the leaf switches 104 to each other. In some cases, the leaf switches 104 can connect endpoint groups to the network fabric 112 and/or any external networks. Each endpoint group can connect to the network fabric 112 via one of the leaf switches 104, for example.

Endpoints 110 A-E (collectively “110”, shown as “EP”) can connect to the network fabric 112 via the leaf switches 104. For example, endpoints 110A and 110B can connect directly to a leaf switch 104A, which can connect the endpoints 110A and 110B to the network fabric 112 and/or any other one of the leaf switches 104. Similarly, an endpoint 110E can connect directly to a leaf switch 104C, which can connect the endpoint 110E to the network fabric 112 and/or any other of the leaf switches 104. On the other hand, endpoints 110C and 110D can connect to a leaf switch 104B via an L2 network 106. Similarly, the Wide Area Network (WAN) can connect to a leaf switch 104N via an L3 network 108.

In certain embodiments, the endpoints 110 can include any communication device, such as a computer, a server, a switch, a router, etc. In some cases, the endpoints 110 can include a server, hypervisor, or switch configured with a VTEP functionality which connects the overlay network with the network fabric 112. For example, in some cases, the endpoints 110 can represent one or more VTEPs. In an example, the VTEPs can connect to the network fabric 112 via the leaf switches 104. The overlay network can host physical devices, such as servers, applications, endpoint groups, virtual segments, virtual workloads, etc. In addition, the endpoints 110 can host virtual workload(s), clusters, and applications or services, which can connect with the network fabric 112 or any other device or network, including an external network. For example, one or more endpoints 110 can host, or connect to, a cluster of load balancers or an endpoint group of various applications.

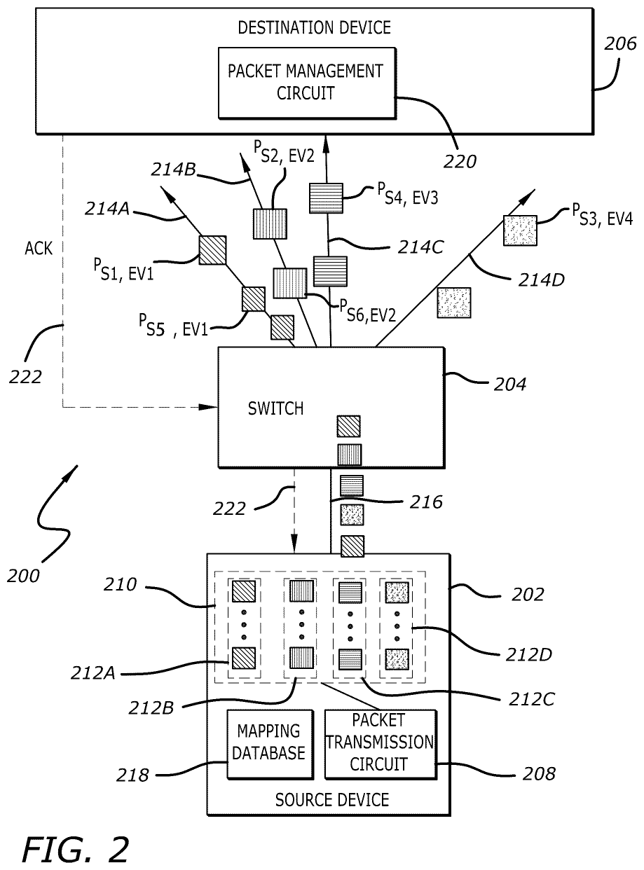

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-9 as required to realize a particularly desired embodiment.

Referring to FIG. 2, a conceptual block diagram 200 for packet loss detection and re-transmission in accordance with various embodiments of the disclosure is shown. In the embodiments shown in FIG. 2, the block diagram 200 may include a source device 202, a switch 204, and a destination device 206. In various examples, the source device 202 may be communicatively coupled to the destination device 206 via the switch 204. As used herein, the source device 202 may correspond to an entity (e.g., a server, a computer, or the like) that is capable of initiating a data transfer process. As used herein, the destination device 206 may correspond to another entity that is capable of receiving data transmitted by the source device 202. As used herein, the switch 204 may correspond to a network device (e.g., an L2 switch, an Access Point, or the like) that is capable of routing incoming data from the source device 202 to the destination device 206. Although it is shown that the source device 202 is communicatively coupled to the destination device 206 via the switch 204, the scope of the present disclosure should not be limited to it. In some more examples, the source device 202 may be communicatively coupled to the destination device 206 via a network fabric (e.g., the network fabric 112 described in the detailed description of FIG. 1).

In a variety of embodiments, the source device 202 may include a packet transmission circuit 208 that is capable of transmitting data to the destination device 206. In an example, the data may be transmitted to the destination device 206 via the switch 204. In various examples, in order to transmit the data, the packet transmission circuit 208 may be configured to segment that data into a plurality of manageable units, for example, a plurality of packets 210. Each packet of the plurality of packets 210 may include a payload and at least one header. In numerous examples, the payload may include a segmented portion of the data. In many examples, the header may include essential information about the corresponding packet, for example, source and destination addresses, a sequence number (also referred to as a Packet Sequence Number “PSN”), a protocol number, error-checking information, or the like.

In various examples, the source and destination addresses may include a source Internet Protocol (IP) address, a destination IP address, a source port number, and a destination port number. In many further examples, the sequence number may be a unique identifier assigned to each packet of the plurality of packets 210. In many additional examples, a plurality of sequence numbers may be assigned to the plurality of packets 210 in such a way that the plurality of sequence numbers is monotonically increasing. In other words, each packet of the plurality of packets 210 may be assigned with a unique sequence number in such a way that the assigned sequence number is greater than the sequence number of a previous packet of the plurality of packets 210. Thus, sequence numbers are monotonically increasing numbers assigned to the plurality of packets 210 for maintaining and recording an order of transmission. In numerous additional examples, the protocol number may specify a type of protocol used to encapsulate the payload.

In a number of embodiments, the packet transmission circuit 208 may be configured to assign one of a plurality of Entropy Values (EVs) to each packet of the plurality of packets 210. In an example, an EV, assigned to a packet and included in a packet header, may serve as an identifier used by the switch 204 to select a forwarding path for the packet. In other words, if the switch 204 and the destination device 206 are communicatively coupled via a plurality of paths, each path may be uniquely identified by an EV of the plurality of EVs. For embodiments shown in FIG. 2, the switch 204 may include first through fourth output ports, which respectively correspond to first through fourth paths 214A-214D between the switch 204 and the destination device 206. Accordingly, the plurality of EVs may include first through fourth EVs (EV=1, 2, 3, 4, for example), where each EV may be associated with a respective output port of the first through fourth output ports. Thus, by varying the EVs, the packet transmission circuit 208 may ensure that the plurality of packets 210 are evenly distributed across multiple paths 214A-214D connecting the switch 204 and the destination device 206.

In various embodiments, the packet transmission circuit 208 may assign the plurality of EVs to the plurality of packets 210 based on a round-robin scheme. For example, if the plurality of EVs includes the first through fourth EVs (EV=1, 2, 3, 4, for example), the packet transmission circuit 208 may assign the first through fourth EVs in a cyclic manner. Thus, a first packet may be assigned EV=1, a second packet EV=2, a third packet EV=3, a fourth packet EV=4, a fifth packet EV=1, and so on. In other words, after the last EV in the sequence of the plurality of EVs is reached, the EVs wrap around and start again from the beginning.

In a variety of embodiments, the packet transmission circuit 208 may be configured to determine a weight for each EV of the first through fourth EVs. In an example, the weight of each EV may be determined based on congestion information associated with the respective output port of the switch 204. For example, the congestion information associated with a specific output port may indicate one or more of: a Round-Trip-Time (RTT) associated with the specific output port, a buffer occupancy associated with the specific output port, an indication of the presence of congestion on the specific output port, an indication of the absence of the congestion on the specific output port, or the like. In many examples, the packet transmission circuit 208 may utilize a Machine learning (ML) process to determine the weights for the first through fourth EVs. For example, the ML process may determine higher weights for one or more EVs of the first through fourth EVs that correspond to output ports experiencing less congestion. Additionally, or alternatively, the ML process may determine lower weights for one or more other EVs of the first through fourth EVs that correspond to output ports experiencing more congestion. The assignment of an EV to a packet may be based on these determined weights. For example, if the first though fourth EVs have weights ‘0.4’, ‘0.3’, ‘0.2’, and ‘0.1’, the packet transmission circuit 208 may assign the first EV to 40% of the plurality of packets 210, the second EV to 30% of the plurality of packets 210, the third EV to 20% of the plurality of packets 210, and the fourth EV to 10% of the plurality of packets 210. In a non-limiting example, it is assumed that the packet transmission circuit 208 has assigned the first EV to a first set of packets 212A among the plurality of packets 210, the second EV to a second set of packets 212B among the plurality of packets 210, the third EV to a third set of packets 212C among the plurality of packets 210, and the fourth EV to a fourth set of packets 212D among the plurality of packets 210. In numerous examples, each set of the first through fourth sets of packets 212A-212D may include one or more non-consecutive packets having the same EV. For the sake of illustration, packets assigned with the same EV are represented with the same pattern. Thus, FIG. 2 illustrates packets in four different patterns, one for each of the first through fourth EVs.

In yet various embodiments, packets that have the same EV may share the same n-tuple combination. Thus, the first set of packets 212A having the first EV may share the same first n-tuple combination and the second set of packets 212B having the second EV may share the same second n-tuple combination. In an example, n-tuple combination may correspond to a 4-tuple combination (e.g., the source and destination IP addresses and the source and destination port numbers), a 5-tuple combination (e.g., the source and destination IP addresses, the source and destination port numbers, and the protocol number), or the like. In more embodiments, mapping between EVs and specific n-tuple fields may be predetermined.

In further embodiments, upon assigning the first through fourth EVs, the packet transmission circuit 208 may be configured to transmit, the plurality of packets 210 to the switch 204 via a communication link 216. The plurality of packets 210 may be transmitted in a predefined order as per the assigned sequence number. For example, a packet with sequence number 1 is transmitted prior to a packet with sequence number 2, and so on.

In still further embodiments, the packet transmission circuit 208 may be further configured to maintain a mapping database 218 for the first through fourth EVs. In many examples, the mapping database 218 may be a tabular database where each row of the mapping database 218 may correspond to a respective EV of the first through fourth EVs and include sequence numbers of unacknowledged packets that are assigned the respective EV. Thus, in a scenario where there are four EVs, the mapping database 218 may include four rows, one row for each of the first through fourth EVs. In an example, a first row of the mapping database 218 may correspond to the first EV and store the sequence numbers of all unacknowledged packets that are assigned the first EV. Likewise, the second row may correspond to the second EV and store the sequence numbers of all unacknowledged packets that are assigned the second EV. Similarly, the third row may correspond to the third EV and store the sequence numbers of all unacknowledged packets that are assigned the third EV, and the fourth row may correspond to the fourth EV and store the sequence numbers of all unacknowledged packets that are assigned the fourth EV.

In still yet further embodiments, for each EV, the sequence numbers may be recorded in the mapping database 218 in a transmission order of corresponding packets. For example, upon transmitting the first set of packets 212A, the packet transmission circuit 208 may be configured to record, in the first row of the mapping database 218, the sequence numbers of the first set of packets 212A in association with the first EV, following the transmission order of the first set of packets 212A. Thus, the sequence number of the latest transmitted packet may recorded at one end of the first row and the sequence number of the oldest unacknowledged transmitted packet may recorded at the opposite end of the first row. Similarly, the packet transmission circuit 208 may be configured to record, in the mapping database 218, the sequence numbers of the second through fourth sets of packets 212B-212D in association with corresponding EVs in a transmission order. In further additional embodiments, the packet transmission circuit 208 may record reduced versions of the unique sequence numbers in association with respective EVs in the mapping database 218, rather than the full sequence numbers. In various examples, the reduced versions of the sequence numbers may correspond to the last ‘B’ bits of the sequence numbers. Accordingly, by recording the reduced versions of the sequence numbers, the packet transmission circuit 208 may be enabled to improve the scalability of the recording process.

In more embodiments, the switch 204 may be configured to receive the first through fourth sets of packets 212A-212D from the source device 202. Upon receiving the first through fourth sets of packets 212A-212D, the switch 204 may be configured to route the first through fourth sets of packets 212A-212D to the destination device 206 via the first through fourth paths 214A-214D. In many examples, the switch 204 may execute a hashing process to route the first through fourth sets of packets 212A-212D to the destination device 206. In an example, upon executing the hashing process, the switch 204 may deliver the first set of packets 212A to the destination device 206 via the first path 214A of the first through fourth paths 214A-214D. Specifically, upon executing the hashing process, the switch 204 may hash, based on the first EV, the first set of packets 212A (denoted as “P_{S1,EV1}” and “P_{S5,EV1}” in FIG. 2) to the first path 214A. Similarly, the switch 204 may route the second set of packets 212B (denoted as “P_{S2,EV2}” and “P_{S6,EV2}” in FIG. 2) to the destination device 206 via the second path 214B. Further, the switch 204 may route the third set of packets 212C (denoted as “P_{S4,EV3}” in FIG. 2) and the fourth set of packets 212D (denoted as “P_{S3,EV4}” in FIG. 2) to the destination device 206 via the third and fourth paths 214C and 214D, respectively.

In still more embodiments, the destination device 206 may be configured to receive, via the switch 204, one or more packets transmitted by the source device 202. In one or more embodiments, the destination device 206 may include a packet management circuit 220 configured to acknowledge successful receipt of delivered packets and transmit negative acknowledgments (NAK) for lost or corrupted packets. In scenarios of reliable unordered delivery, the packet management circuit 220 may be further configured to execute packet ordering, ensuring that packets are reassembled in the correct sequence based on their assigned unique sequence numbers.

In yet more embodiments, upon receiving a packet of the plurality of packets 210, the packet management circuit 220 may be configured to transmit, to the source device 202, an acknowledgment (ACK) for the delivered packet. For example, upon receiving a packet (denoted as “P_{S1,EV1}” in FIG. 2) of the first set of packets 212A, the packet management circuit 220 may transmit, to the source device 202, an ACK 222 for the packet. In various examples, the ACK 222 may be transmitted to the source device 202 via the switch 204. In numerous examples, the ACK 222 may include an EV (denoted as “EV1” in FIG. 2) of the packet and a sequence number (denoted as “S1” in FIG. 2) of the packet.

In still yet more embodiments, the source device 202 may be configured to receive, from the destination device 206, the ACK 222 via the switch 204. Upon receiving the ACK 222, the packet transmission circuit 208 may be configured to extract the first EV and the sequence number included in the ACK 222. Upon extracting the first EV and the sequence number, the packet transmission circuit 208 may be configured to detect whether a packet loss corresponding to the first EV has occurred in the flow. In various examples, in order to detect the packet loss corresponding to the first EV, the packet transmission circuit 208 may be configured to perform a look-up in the mapping database 218 based on the extracted first EV and the extracted sequence number. Further, the packet transmission circuit 208 may determine, based on the look-up, whether the mapping database 218 indicates a presence of one or more unacknowledged packets, of the first set of packets 212A, that are transmitted prior to the delivered packet (e.g., P_{S1,EV1}).

In several embodiments, in order to determine whether the mapping database 218 indicates the presence of the one or more unacknowledged packets, the packet transmission circuit 208 may be configured to identify a row of the mapping database 218 that corresponds to the extracted first EV. Upon identifying the row, the packet transmission circuit 208 may be configured to determine, in the identified row, whether one or more sequence numbers exist preceding the sequence number extracted from the received acknowledgment. For example, if the one or more sequence numbers exist preceding the extracted sequence number in the identified row, the packet transmission circuit 208 may determine that the mapping database 218 indicates the presence of the one or more unacknowledged packets. For example, if the sequence number ‘S1’ is not present at a tail end of the first row, the packet transmission circuit 208 may determine that the mapping database 218 indicates the presence of the one or more unacknowledged packets. Conversely, if the one or more sequence numbers do not exist preceding the extracted sequence number in the identified row, the packet transmission circuit 208 may determine that the mapping database 218 indicates an absence of the one or more unacknowledged packets. For example, if the sequence number ‘S1’ is present at a tail end of the first row, the packet transmission circuit 208 may determine that the mapping database 218 indicates the absence of the one or more unacknowledged packets.

In several more embodiments, if the mapping database 218 indicates the absence of the one or more unacknowledged packets, the packet transmission circuit 208 may be configured to detect that the packet loss corresponding to the first EV has not occurred in the flow. Upon detecting that the packet loss corresponding to the first EV has not occurred in the flow, the packet transmission circuit 208 may be configured to remove the sequence number of the delivered packet from the mapping database 218.

In additional embodiments, if the mapping database 218 indicates the presence of the one or more unacknowledged packets, the packet transmission circuit 208 may be configured to detect that the packet loss corresponding to the first EV has occurred in the flow. Upon detecting that the packet loss corresponding to the first EV has occurred in the flow, the packet transmission circuit 208 may be configured to identify, based on the one or more sequence numbers that exist preceding the extracted sequence number, one or more unacknowledged packets in the first set of packets 212A. Upon identifying the one or more unacknowledged packets, the packet transmission circuit 208 may be configured to re-transmit, via the switch 204, the unacknowledged packets to the destination device 206.

In still additional embodiments, upon re-transmitting the unacknowledged packets, the packet transmission circuit 208 may be configured to remove, from the mapping database 218, the one or more sequence numbers of the one or more unacknowledged packets. In still yet additional embodiments, the packet transmission circuit 208 may be configured to remove the sequence number of the delivered packet from the mapping database 218. In numerous additional embodiments, the packet transmission circuit 208 may be configured to record in the mapping database 218, in a transmission order of the one or more unacknowledged packets, a set of new sequence numbers of the re-transmitted one or more unacknowledged packets in association with the first EV.

Although the source device 202 receiving the ACK 222 for the packet (“P_{S1,EV1}”) is described as an example, the scope of the present disclosure should not be limited to this example. In some more embodiments, the source device 202 may receive an ACK for each packet received by the destination device 206. In these embodiments, the source device 202 may perform the packet loss detection process for each received ACK, similar to the packet loss detection process performed for the received ACK 222.

In this way, the source device 202 may be configured to re-transmit, to the destination device 206, one or more lost packets (e.g., the one or more unacknowledged packets) based on the reception of an ACK for a packet that is transmitted subsequent to one or more unacknowledged packets. In various examples, the source device 202 may re-transmit the one or more unacknowledged packets, independent of timing out and/or Negative Acknowledgment (NACK) for the one or more unacknowledged packets. Accordingly, the source device 202 may suppress the dependency on time-outs and/or the NACK for detecting packet loss and re-transmission. Therefore, the source device 202 may significantly reduce the delays in the re-transmission of the lost packets.

The packet management circuit 220 may be further configured to reconstruct the data based on receiving the plurality of packets 210. In various examples, in order to reconstruct the data, the packet management circuit 220 may be configured to examine the header of each packet of the plurality of packets 210 to extract the unique sequence numbers. Further, the packet management circuit 220 may be configured to sort the plurality of packets 210 based on the extracted sequence numbers. Furthermore, the packet management circuit 220 may be configured to combine the sorted plurality of packets 210 to reconstruct the data.

Although a specific embodiment of the block diagram 200 is described above with respect to FIG. 2, any of a variety of systems and/or processes may be utilized in accordance with embodiments of the disclosure. For example, the block diagram 200 may include multiple destination devices, similar to the destination device 206. In this example, the source device 202 may be configured to maintain a separate mapping database for each of the destination devices. Further, examples of the packet transmission circuit 208 and the packet management circuit 220 Application-Specific Integrated Circuit (ASIC) processors, Complex Instruction Set Computing (CISC) processors, Central Processing Units (CPUs), Explicitly Parallel Instruction Computing (EPIC) processors, Very Long Instruction Word (VLIW) processors, or other processors or circuits. The elements depicted in FIG. 2 may also be interchangeable with other elements of FIG. 1 and FIGS. 3-9 as required to realize a particularly desired embodiment.

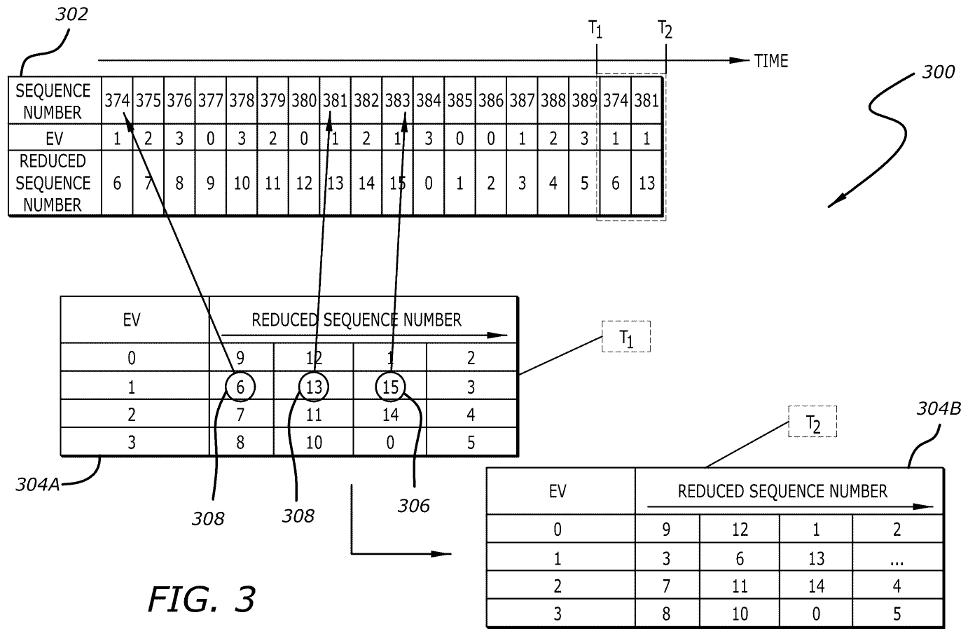

Referring to FIG. 3, a conceptual block diagram 300 for updating a mapping database in event of packet loss in accordance with various embodiments of the disclosure is shown. FIG. 3 illustrates a transmission sequence 302 for a flow of packets transmitted by a source device. The transmission sequence 302 indicates unique sequence numbers (e.g., sequence numbers “374” to “389”) of the transmitted packets and a series of EVs (e.g., EVs “0” to “3”) assigned to the transmitted packets. The transmission sequence 302 further indicates reduced sequence numbers (e.g., reduced sequence numbers “0” to “15”) corresponding to the actual sequence numbers of the transmitted packets. For example, as indicated in the transmission sequence 302, a packet having a sequence number 374 is assigned an EV ‘1’,while another packet having a sequence number 375 is assigned an EV ‘2’. In the example embodiment shown in FIG. 3, the reduced sequence numbers are obtained based on a Modulo N (e.g., Modulo 16) operation performed on the full sequence numbers.

In various embodiments, based on transmission of the packets indicated in the transmission sequence 302, the source device may be configured to update a mapping database to record in the mapping database, the unique sequence numbers or unique reduced sequence numbers of the transmitted packets in association with respective EVs, in the transmission order. The mapping database may be created in such a way that each row of the mapping database is associated with a respective EV of the series of EVs and stores sequence numbers or reduced sequence numbers of unacknowledged packets that are assigned the respective EV. For each EV, the sequence numbers may be recorded to follow the transmission order of the packets. For example, for each EV, sequence number of the latest transmitted packet may be recorded in the rightmost empty cell of the corresponding row, and the oldest unacknowledged packet may be stored in the leftmost cell of the corresponding row. In an example, the rows of the mapping database may be implemented as rolling buffers

In an example, a mapping database 304A may depict a state of the mapping database at a first time point (denoted as “T₁” in FIG. 3). The first time point T₁ may refer to a time instance at which a packet having the sequence number 389 is transmitted. As shown in the mapping database 304A, a first row corresponding to the EV ‘0’ has 4 reduced sequence numbers (‘9’, ‘12’, ‘1’, ‘2’) recorded in it, thus, indicating that at the first time point T₁, EV ‘0’has 4 unacknowledged packets recorded in the mapping database 304A with the sequence number ‘9’ belonging to the oldest unacknowledged transmitted packet and the sequence number ‘2’ belonging to the latest unacknowledged transmitted packet. Likewise, a second row corresponding to the EV ‘1’ also has 4 reduced sequence numbers (‘6’, ‘13’, ‘15’, ‘3’) recorded in it, thus, indicating that at the first time point T₁, EV ‘1’ has 4 unacknowledged packets recorded in the mapping database 304A with the sequence number ‘6’ belonging to the oldest unacknowledged transmitted packet and the sequence number ‘3’ belonging to the latest unacknowledged transmitted packet. Similarly, a third row corresponding to the EV ‘2’ has 4 reduced sequence numbers (‘7’, ‘11’, ‘14’, ‘4’) and a fourth row corresponding to the EV ‘3’ has 4 reduced sequence numbers (‘8’, ‘10’, ‘0’, ‘5’) recorded in them.

In the embodiments shown in FIG. 3, at the first time point T₁, the source device may receive an ACK for a delivered packet. The received ACK may include a target EV (for example, “1”) and a sequence number (with a value of “383”) of the delivered packet. Upon receiving the ACK, the source device may identify a reduced sequence number ‘15’ (enclosed within a circle 306) corresponding to the sequence number included in the ACK. Upon identifying the reduced sequence number, the source device may further identify a row of the mapping database 304A that corresponds to the target EV ‘1’ included in the ACK. Upon identifying the row, the source device may determine, in the identified row, whether one or more reduced sequence numbers exist preceding the reduced sequence number ‘15’. For the embodiments shown in FIG. 3, the source device may determine that a set of reduced sequence numbers ‘6’ and 13’ (enclosed within circles 308) exists preceding the reduced sequence number ‘15’.

In still additional embodiments, upon determining that the set of reduced sequence numbers ‘6’ and ‘13’ exists preceding the reduced sequence number ‘15’, the source device may detect that the packet loss corresponding to the target EV ‘1’ included in the ACK has occurred. Upon detecting that the packet loss has occurred, the source device may identify, as a set of unacknowledged packets (or as a set of lost packets), packets corresponding to the set of reduced sequence numbers ‘6’ and ‘13’. Upon identifying the set of unacknowledged packets, the source device may re-transmit the set of unacknowledged packets. For example, as shown in the transmission sequence 302, packets with sequence numbers ‘374’ and ‘381’ are re-transmitted.

In more embodiments, the source device may update the mapping database 304A to obtain updated mapping database 304B at a second time point (denoted as “T₂” in FIG. 3). In many examples, the mapping database 304A may be updated after the re-transmission of the set of unacknowledged packets, for example. In various examples, in order to update the mapping database 304A, the source device may remove, from the mapping database 304A, the set of reduced sequence numbers ‘6’ and ‘13’ based on the re-transmission of the set of unacknowledged packets. Further, the source device may remove, from the mapping database 304A, the sequence number ‘15’ based on the reception of the ACK. Furthermore, the source device may perform a shift operation (e.g., a left-shift operation) on the identified row. In the shift operation, the source device may move the remaining sequence numbers in the identified row to the left. Furthermore, the source device may record, in the identified row, a set of new reduced sequence numbers corresponding to the re-transmitted set of unacknowledged packets, following the re-transmission order of the flow. Consequently, the mapping database 304A may be updated to obtain the mapping database 304B.

Although a specific embodiment of the block diagram 300 is described above with respect to FIG. 3, any of a variety of systems and/or processes may be utilized in accordance with embodiments of the disclosure. For example, upon receiving a new ACK for a packet corresponding to the reduced sequence number of ‘3’ at the second time point, the source device may be further configured to remove the reduced sequence number of ‘3’ from the mapping database 304B. Though in FIG. 3, the re-transmitted packets are shown to be assigned the same EV ‘1’, the scope of the disclosure is not limited to it. In various additional embodiments, the re-transmitted packets may be assigned a different EV than the original EV associated with the packet loss. Further, in scenarios where the EVs are assigned based on a round robin scheme, a distance from the received acknowledgment can be determined and any unacknowledged packet in the identified row of the mapping database that is beyond 2 times the sequence number in the acknowledgment may be retransmitted. The elements depicted in FIG. 3 may also be interchangeable with other elements of FIGS. 1-2 and FIGS. 4-9 as required to realize a particularly desired embodiment.

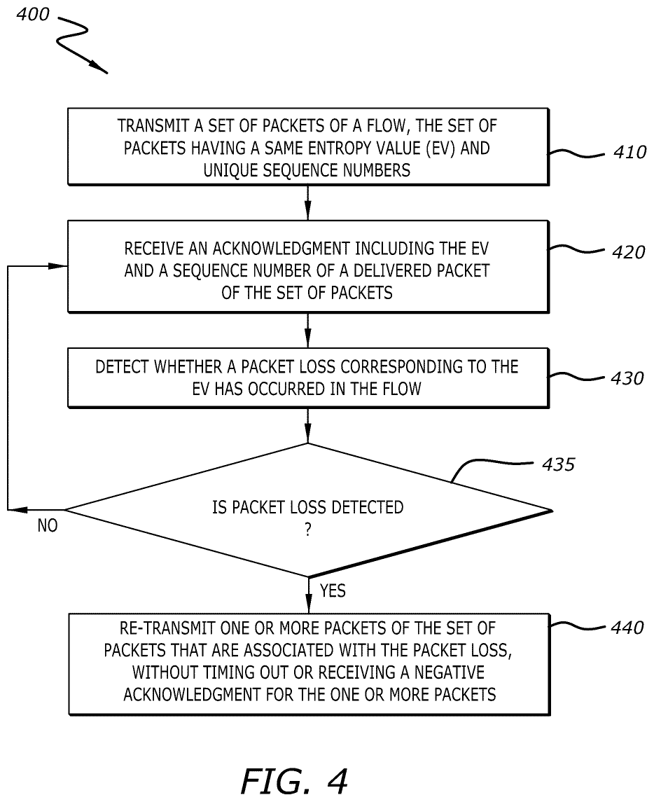

Referring to FIG. 4, a flowchart depicting a process 400 for packet re-transmission in accordance with various embodiments of the disclosure is shown. In various embodiments, the process 400 may be implemented within a digital communication network. In an example, the digital communication network may include a source device, at least one network device (e.g., a switch), and a destination device. In various examples, the source device may implement the process 400.

In many embodiments, the process 400 may transmit a set of packets of a flow (block 410). In various examples, the process 400 may transmit the set of packets to the destination device via the switch. In many examples, the process 400 may be configured to generate data for at least one application associated with the destination device. Upon generating the data, the process 400 may segment the data into a plurality of packets. In various examples, each packet of the plurality of packets may include a payload and at least one header. In an example, the payload may include a segmented portion of the data. For example, the header may include essential information about the corresponding packet, for example, source and destination addresses, a sequence number, a protocol number, error-checking information, or the like. In numerous examples, the source and destination addresses may include a source IP address, a destination IP address, a source port number, and a destination port number.

In many additional embodiments, upon segmenting the data, the process 400 may assign one of a plurality of EVs to each of the plurality of packets. In more embodiments, mapping between EVs and specific n-tuple fields may be predetermined. Thus, packets assigned with the same may have the same n-tuple field combination. In an example, the tuple combination may be one of a 4-tuple combination (e.g., the source and destination IP addresses and the source and destination port numbers) or a 5-tuple combination (e.g., the source and destination IP addresses, the source and destination port numbers, and the protocol number). In an example, the process 400 may assign the EVs to the plurality of packets based on a round-robin scheme or one or more weights associated with the plurality of EVs. The transmitted set of packets may have the same EV and unique sequence numbers. In various embodiments, the set of packets may include non-consecutive packets of the flow.

In further embodiments, the process 400 may receive an acknowledgment for a delivered packet of the set of packets (block 420). In an example, the process 400 may receive the acknowledgment from the destination device via the switch. In various examples, the received acknowledgment may include the EV and a sequence number of the delivered packet. Upon receiving the acknowledgment, the process 400 may extract the EV and the sequence number of the delivered packet from the acknowledgment.

In still further embodiments, the process 400 may detect whether a packet loss corresponding to the EV has occurred in the flow (block 430). In various examples, the process 400 may detect whether the packet loss corresponding to the EV has occurred or not based on the EV and the sequence number extracted from the received acknowledgment. For example, the process 400 may determine whether one or more unacknowledged packets that are assigned the same EV as the acknowledged packet and that have older sequence numbers than the acknowledged packet exist. In other words, the process 400 may determine whether one or more unacknowledged packets that are assigned the same EV as the acknowledged packet and were transmitted prior to the acknowledged packet exist. In a scenario where such one or more unacknowledged packets are determined to exist, the process 400 may detect that packet loss corresponding to the EV has occurred. However, if such one or more unacknowledged packets do not exist, the process 400 may detect that packet loss corresponding to the EV has not occurred.

In still yet further embodiments, the process 400 may determine whether the packet loss corresponding to the EV is detected (block 435). In further additional embodiments, if the packet loss corresponding to the EV is not detected, the process 400 may receive another acknowledgment including the EV and another sequence number of another delivered packet of the set of packets (block 420). In an example, the process 400 may receive the acknowledgment from the destination device via the switch.

In additional embodiments, if the packet loss corresponding to the EV is detected, the process 400 may re-transmit one or more packets of the set of packets that are associated with the packet loss (block 440). The one or more packets of the set of packets that are associated with the packet loss may include the one or more unacknowledged packets that are assigned the same EV as the acknowledged packet and were transmitted prior to the acknowledged packet. Accordingly, the process 400 may re-transmit the one or more packets that are associated with the packet loss, without timing out or receiving a negative acknowledgment for the one or more packets. Therefore, the process 400 may suppress the dependency on time-outs and/or the negative acknowledgment. Consequently, the process 400 may reduce the delays in the re-transmission of the one or more packets that are associated with the packet loss.

Although a specific embodiment of the process 400 is described above with respect to FIG. 4, any of a variety of systems and/or processes may be utilized in accordance with embodiments of the disclosure. For example, the process 400 may utilize an EV to sequence number mapping database to detect the packet loss. The elements depicted in FIG. 4 may also be interchangeable with other elements of FIGS. 1-3 and FIGS. 5-9 as required to realize a particularly desired embodiment.

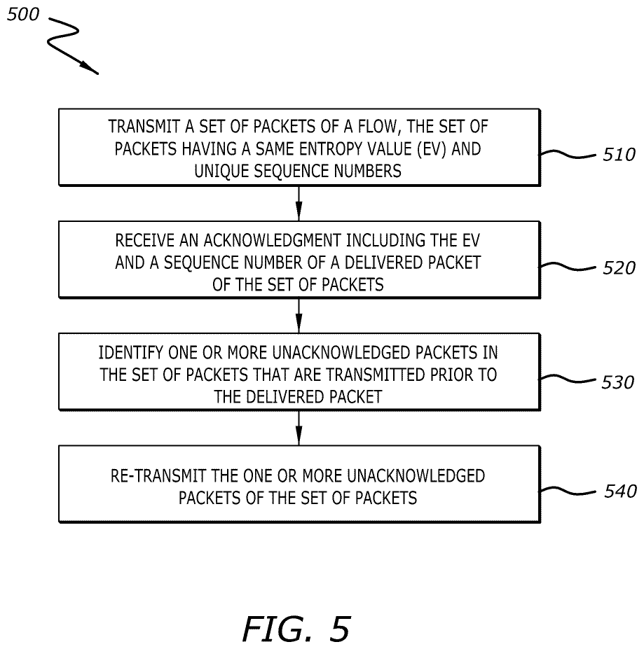

Referring to FIG. 5, a flowchart depicting a process 500 for packet re-transmission in accordance with various embodiments of the disclosure is shown. In various embodiments, the process 500 may be implemented within a digital communication network. In an example, the digital communication network may include a source device, at least one network device (e.g., a switch), and a destination device. In various examples, the source device may implement the process 500.

In many embodiments, the process 500 may transmit a set of packets of a flow (block 510). In various examples, the process 500 may transmit the set of packets to the destination device via the switch. In numerous examples, the set of packets may include one or more packets of the flow, each with a unique sequence number. However, the packets may share the same EV. Consequently, the set of packets may have the same EV and unique sequence numbers. In an example, the EV may be mapped to a predetermined n-tuple combination. In numerous additional examples, the process 500 may transmit, to the destination device, the set of packets with anticipation that the destination device will transmit an acknowledgment for each delivered packet of the set of packets.

In additional embodiments, the process 500 may receive an acknowledgment for a delivered packet of the set of packets (block 520). In an example, the process 500 may receive the acknowledgment from the destination device via the switch. In various examples, the received acknowledgment may include the EV and a sequence number of the delivered packet.

In still additional embodiments, the process 500 may identify one or more unacknowledged packets in the set of packets that are transmitted prior to the delivered packet (block 530). In various examples, in order to identify the one or more unacknowledged packets, the process 500 may extract, from the received acknowledgment, the EV and the sequence number of the delivered packet. Upon extracting the EV and the sequence number, the process 500 may identify whether one or more unacknowledged packets that are assigned the same EV as the delivered packet and that have older sequence numbers than the delivered packet exist. Packets having older sequence numbers may signify prior transmission than the delivered packet as sequence numbers are uniquely assigned in an increasing order to packets of the flow.

In still yet additional embodiments, the process 500 may re-transmit the one or more unacknowledged packets of the set of packets (block 540). In an example, the process 500 may re-transmit the one or more unacknowledged packets to the destination device via the switch. Accordingly, the process 500 may re-transmit the one or more unacknowledged packets that are associated with the packet loss, without timing out for the one or more packets. Therefore, the process 500 may suppress the dependency on time-outs. Consequently, the process 500 may reduce the delays in the re-transmission of the one or more packets that are associated with the packet loss.

Although a specific embodiment of the process 500 is described above with respect to FIG. 5, any of a variety of systems and/or processes may be utilized in accordance with embodiments of the disclosure. For example, the process 500 may re-transmit the one or more unacknowledged packets without receiving a negative acknowledgment for the one or more unacknowledged packets. The elements depicted in FIG. 5 may also be interchangeable with other elements of FIGS. 1-4 and FIGS. 6-9 as required to realize a particularly desired embodiment.

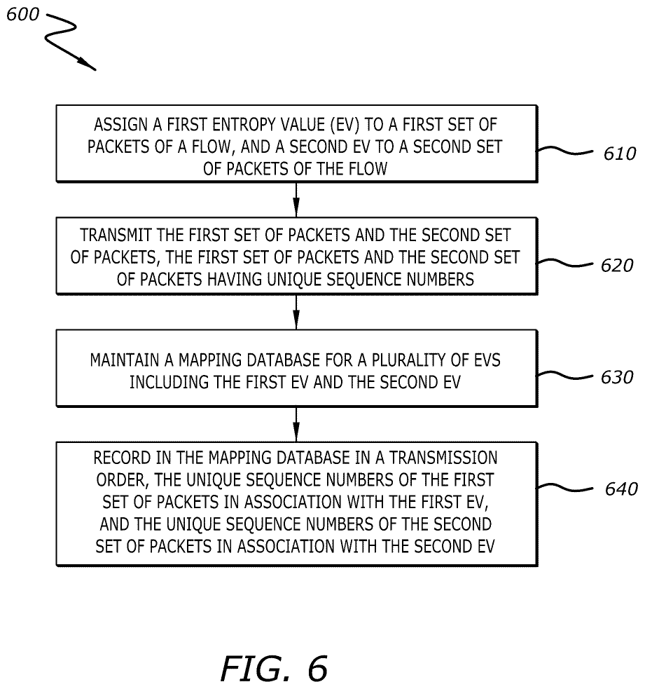

Referring to FIG. 6, a flowchart depicting a process 600 for recording sequence numbers in accordance with various embodiments of the disclosure is shown. In various embodiments, the process 600 may be implemented within a digital communication network. In an example, the digital communication network may include a source device, at least one network device (e.g., a switch), and a destination device. In various examples, the source device may implement the process 600.

In many embodiments, the process 600 may assign a first EV to a first set of packets of a flow and a second EV to a second set of packets of the flow (block 610). In a number of embodiments, the process 600 may assign the first EV and the second EV based on a round-robin scheme. For example, the process 600 may assign the first and second EVs in a cyclic manner. Thus, a first packet may be assigned EV=1, a second packet EV=2, a third packet EV=1, and so on. In other words, after the last EV in the sequence of the plurality of EVs is reached, the EVs wrap around and start again from the beginning. The packets that are assigned the first EV may correspond to the first set of packets and the packets that are assigned the second EV may correspond to the second set of packets. In a variety of embodiments, the process 600 may determine weights for the first EV and the second EV, and the assignment of an EV to a packet may be based on these determined weights. In various examples, the weights may be determined based on congestion information associated with the first EV and the second EV. For example, if first EV (EV=1) has a weight of 0.7 and the second EV (EV=2) has a weight of 0.3, the process 600 may assign the first EV to 70% packets of the flow and the second EV to the remaining 30% packets. Here, the 70% packets of the flow may correspond to the first set of packets and the 30% packets may correspond to the second set of packets. Since the first EV and the second EV are assigned as per a round-robin scheme, determined weights, or other EV assignment techniques, the same EV may be assigned to non-consecutive packets of the flow. In other words, the first set of packets may include packets with non-consecutive sequence numbers.

In further embodiments, the process 600 may transmit the first set of packets and the second set of packets (block 620). In an example, each of the first and second sets of packets may include packets having unique sequence numbers. In various examples, the process 600 may transmit the first and second sets of packets to the destination device via the switch. In numerous examples, the process 600 may transmit, to the destination device, the first and second sets of packets with anticipation that the destination device will transmit an acknowledgment for each delivered packet of the first and second sets of packets. Further, the process 600 may transmit the first set of packets and the second set of packets in a transmission order defined by the unique sequence numbers.

In more embodiments, the process 600 may maintain a mapping database for a plurality of EVs including the first EV and the second EV (block 630). In more examples, the mapping database may be a tabular database including a plurality of rows. In various examples, each row of the mapping database may correspond to a unique respective EV and store sequence numbers of unacknowledged packets that are assigned with the respective EV. In an example, the mapping database may include first and second rows, where the first row may correspond to the first EV and store the sequence numbers of the unacknowledged packets having the first EV. Likewise, the second row correspond to the second EV and store the sequence numbers of the unacknowledged packets having the second EV. For each EV, the sequence numbers may be recorded as per their transmission order. In various embodiments, each row of the mapping database may have a predetermined depth ‘N’. The predetermined depth ‘N’ may be based on number the source device can transmit to the destination device within a round trip time. In example, the count of plurality of EVs can be 256. In many further embodiments, the process 600 may maintain a different mapping database for each flow.

In additional embodiments, the process 600 may record in the mapping database in a transmission order, the unique sequence numbers of the first set of packets in association with the first EV, and the unique sequence numbers of the second set of packets in association with the second EV (block 640). Specifically, the unique sequence numbers of the first set of packets and the unique sequence numbers of the second set of packets may be recorded in the first and second rows of the mapping database, respectively, following the transmission order. For example, upon transmitting the first set of packets, the process 600 may record, in the first row of the mapping database, the sequence numbers of the first set of packets in association with the first EV, following the transmission order of the first set of packets. Thus, the sequence number of the latest transmitted packet may recorded at one end of the first row and the sequence number of the oldest unacknowledged transmitted packet may recorded at the opposite end of the first row.

Although a specific embodiment of the process 600 is described above with respect to FIG. 6, any of a variety of systems and/or processes may be utilized in accordance with embodiments of the disclosure. For example, the process 600 may record reduced versions of the unique sequence numbers in association with respective EVs in the mapping database, rather than the full sequence numbers. The reduced versions of the sequence numbers may correspond to the last ‘B’ bits of the sequence numbers. The process 600 may utilize received acknowledgments and the mapping database to detect packet loss. Accordingly, by recording the reduced versions of the sequence numbers, the packet transmission circuit 208 may be enabled to improve the scalability of the recording process. The elements depicted in FIG. 6 may also be interchangeable with other elements of FIGS. 1-5 and FIGS. 7-9 as required to realize a particularly desired embodiment.

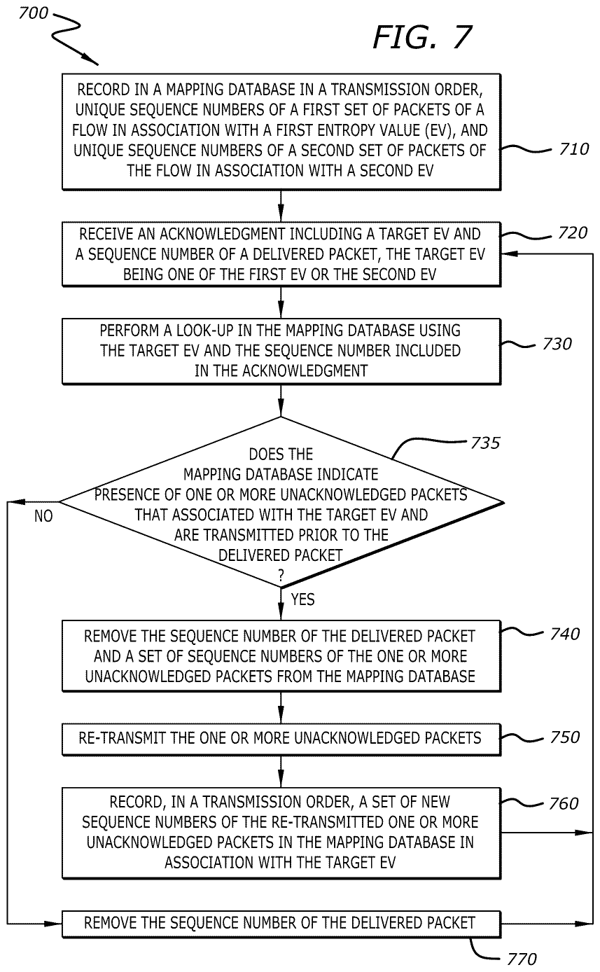

Referring to FIG. 7, a flowchart depicting a process 700 for removing sequence numbers in accordance with various embodiments of the disclosure is shown. In various embodiments, the process 700 may be implemented within a digital communication network. In an example, the digital communication network may include a source device, at least one network device (e.g., a switch), and a destination device. In various examples, the source device may implement the process 700.

In many embodiments, the process 700 may record in a mapping database in a transmission order, unique sequence numbers of a first set of packets of a flow in association with a first EV, and unique sequence numbers of a second set of packets of the flow in association with a second EV (block 710). In many examples, prior to recording the unique sequence numbers of the first set of packets and the unique sequence numbers of the second set of packets, the process 700 may transmit the first set of packets and the second set of packets to the destination device via the switch. Upon transmitting the first and second sets of packets, the process 700 may record, in the mapping database, the unique sequence numbers of the first set of packets and the unique sequence numbers of the second set of packets, following the transmission order. In various examples, the mapping database may correspond to a tabular database that is maintained for the first and second EVs. In an example, the mapping database may include first and second rows, where the first row can be configured to store sequence numbers of unacknowledged packets corresponding to the first EV and the second row can store sequence numbers of unacknowledged packets corresponding to the second EV. In numerous examples, the process 700 may record the unique sequence numbers of the first set of packets and the unique sequence numbers of the second set of packets in the first and second rows, respectively, as per the transmission order. For example, upon transmitting the first set of packets, the process 700 may record, in the first row of the mapping database, the sequence numbers of the first set of packets in association with the first EV, following the transmission order of the first set of packets. Thus, the sequence number of the latest transmitted packet may recorded at one end of the first row and the sequence number of the oldest unacknowledged transmitted packet may recorded at the opposite end of the first row.

In many further embodiments, the process 700 may receive an acknowledgment including a target EV and a sequence number of a delivered packet (block 720). In various examples, the target EV may correspond to one of the first EV or the second EV. In numerous examples, the process 700 may receive, from the destination device via the switch, the acknowledgment based on the transmission of the first and second sets of packets.

In further embodiments, the process 700 may perform a look-up in the mapping database using the target EV and the sequence number included in the acknowledgment (block 730). In many examples, performing the look-up may include identifying, in the mapping database, a row that corresponds to the target EV. In many further examples, performing the look-up may include determining, in the identified row, whether one or more sequence numbers exist preceding the sequence number of the delivered packet.

In still further embodiments, the process 700 may determine whether the mapping database indicates the presence of one or more unacknowledged packets that are associated with the target EV and are transmitted prior to the delivered packet (block 735). In an example, if the one or more sequence numbers exist preceding the sequence number of the delivered packet, the process 700 may determine that the mapping database indicates the presence of one or more unacknowledged packets that are transmitted prior to the delivered packet. In other words, the process 700 may determine whether the identified row corresponding to the target EV includes older sequence numbers than the sequence number included in the received acknowledgment. Conversely, if the one or more sequence numbers do not exist preceding the sequence number of the delivered packet, the process 700 may determine that the mapping database does not indicate the presence of one or more unacknowledged packets.

In still yet further embodiments, if the mapping database indicates the presence of one or more unacknowledged packets, the process 700 may remove, from the mapping database, the sequence number of the delivered packet and a set of sequence numbers of the one or more unacknowledged packets (block 740). Specifically, the sequence number of the delivered packet and the one or more sequence numbers that exist preceding the sequence number of the delivered packet may be removed from the identified row of the mapping database.

In further additional embodiments, the process 700 may re-transmit the one or more unacknowledged packets (block 750). In an example, the process 700 may re-transmit the one or more unacknowledged packets to the destination device via the switch. In various examples, the process 700 may re-transmit one or more packets corresponding to the one or more sequence numbers that exist preceding the sequence number of the delivered packet in the identified row. Consequently, the process 700 may re-transmit the one or more unacknowledged packets without timing out or receiving a negative acknowledgment for the one or more unacknowledged packets.

In additional embodiments, the process 700 may record, in a transmission order, a set of new sequence numbers of the re-transmitted one or more unacknowledged packets in the mapping database in association with the target EV (block 760). Specifically, the set of new sequence numbers of the re-transmitted one or more unacknowledged packets may be recorded in the identified row of the unacknowledged packet table, following the transmission (or re-transmission) order. In some more examples, upon recording the set of new sequence numbers, the process 700 may receive another acknowledgment for another delivered packet (block 720).

In more embodiments, if the mapping database does not indicate the presence of one or more unacknowledged packets, the process 700 may remove the sequence number of the delivered packet (block 770). In some more examples, upon removing the sequence number of the delivered packet, the process 700 may receive another acknowledgment for another delivered packet (block 720).

Although a specific embodiment of the process 700 is described above with respect to FIG. 7, any of a variety of systems and/or processes may be utilized in accordance with embodiments of the disclosure. For example, prior to transmitting the first and second sets of packets, the process 700 may assign the first and second EVs to the first and second sets of packets, respectively. The elements depicted in FIG. 7 may also be interchangeable with other elements of FIGS. 1-6 and FIGS. 8-9 as required to realize a particularly desired embodiment.

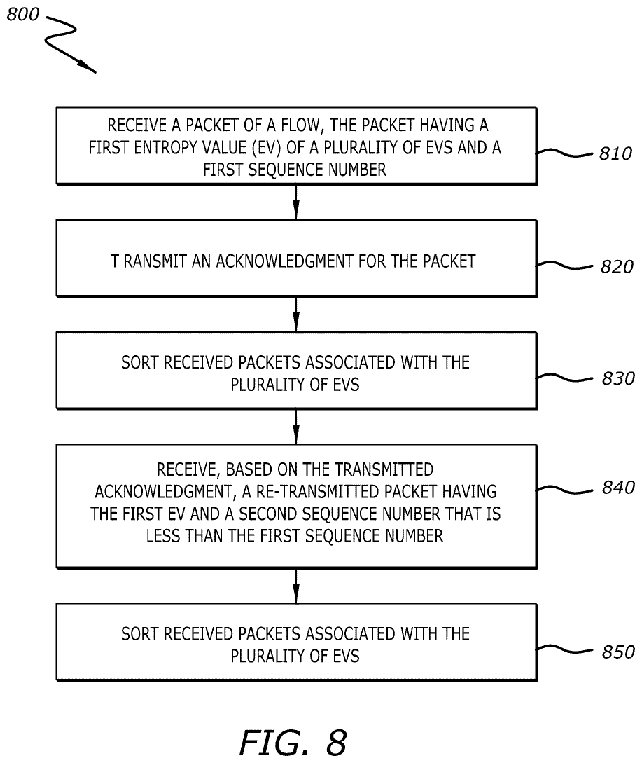

Referring to FIG. 8, a flowchart depicting a process 800 for sorting one or more packets in accordance with various embodiments of the disclosure is shown. In various embodiments, the process 800 may be implemented within a digital communication network. In an example, the digital communication network may include a source device, at least one network device (e.g., a switch), and a destination device. In various examples, the destination device may implement the process 800.

In many embodiments, the process 800 may receive a packet of a flow (block 810). In many examples, the process 800 may receive the packet from the source device via the switch. In various examples, the received packet may include a first EV of a plurality of EVs and a first sequence number. In an example, the first sequence number may be a unique identifier assigned to the packet. In numerous examples, the first EV may be mapped to a specific version of a n-tuple combination associated with the packet. In numerous additional examples, the first EV may be a specific value that is assigned to the packet based on the n-tuple combination associated with the packet. In many additional embodiments, upon receiving the packet, the process 800 may receive a set of packets of the flow having a second EV of the plurality of EVs and a set of sequence numbers.

In further embodiments, the process 800 may transmit an acknowledgment for the packet (block 820). In further examples, the process 800 may transmit, to the source device via the switch, the acknowledgment based on the reception of the packet. In various examples, the acknowledgment may indicate a successful delivery of the packet. In numerous examples, the acknowledgment may include the first EV and the first sequence number.

In still further embodiments, the process 800 may sort the received packets associated with the plurality of EVs (block 830). In various examples, the received packets may include the received packet having the first EV and the received set of packets having the second EV. In some more examples, the received packets may be sorted in a single database. In many examples, the received packets may be sorted based on the first sequence number associated with the received packet and the set of sequence numbers associated with the received set of packets.

In additional embodiments, the process 800 may receive, based on the transmitted acknowledgment, a re-transmitted packet having the first EV and a second sequence number (block 840). In various examples, the process 800 may receive the re-transmitted packet from the source device via the switch. In many examples, the re-transmitted packet may be a lost packet of the flow that corresponds to the first EV and was supposed to be received prior to the reception of the packet. Consequently, the second sequence number of the re-transmitted may be lesser than the first sequence number.

In more embodiments, the process 800 may sort the received packets associated with the plurality of EVs (block 850). In various examples, the received packets may include the received packet having the first EV, the set of packets having the second EV, and the re-transmitted packet having the first EV. In many examples, the received packets may be sorted based on the first sequence number associated with the received packet, the set of sequence numbers associated with the received set of packets, and the second sequence number associated with the re-transmitted packet.

Although a specific embodiment of the process 800 is described above with respect to FIG. 8, any of a variety of systems and/or processes may be utilized in accordance with embodiments of the disclosure. For example, the process 800 may utilize the sorted packets to reconstruct data for one or more applications associated with the destination device. The elements depicted in FIG. 8 may also be interchangeable with other elements of FIGS. 1-7 and FIG. 9 as required to realize a particularly desired embodiment.

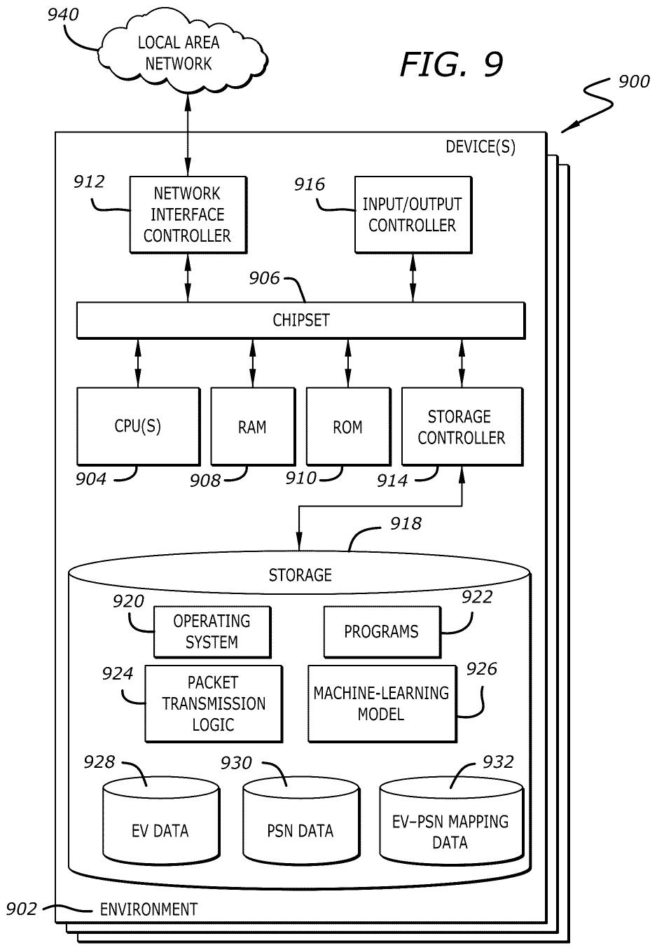

Referring to FIG. 9, a conceptual block diagram of a device 900 suitable for configuration with a packet transmission logic in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 (e.g., a source device) may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (“RAM”) 908, which can be used as the main memory in the device 900 in some embodiments. The chipset 906 can further be configured to provide an interface to a computer-readable storage medium such as a read-only memory (“ROM”) 910 or non-volatile RAM (“NVRAM”) for storing basic routines that can help with various tasks such as, but not limited to, starting up the device 900 or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (“NIC”) 912, which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, programs 922 (e.g., applications), EV data 928, PSN data 930, and EV-PSN mapping data 932 which are described in greater detail below. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In still more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by one or more devices similar to device 900. Stated otherwise, some or all of the operations performed by the cloud computing network, and or any components included therein, may be performed by one or more devices 900 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as program 922 (e.g., application) and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8 . In certain embodiments, the device 900 can also include computer-readable storage media having instructions stored thereupon for performing any of the other computer-implemented operations described herein.

In many further embodiments, the device 900 may include a packet transmission logic 924. The packet transmission logic 924 can be configured to perform one or more of the various steps, processes, operations, or other methods that are described above. Often, the packet transmission logic 924 can be a set of instructions stored within a non-volatile memory that, when executed by the processor(s) 904 can carry out these steps, etc. In some embodiments, the packet transmission logic 924 may be a client application that resides on a network-connected device, such as, but not limited to, a server, switch, personal or mobile computing device in a single or distributed arrangement.

To minimize communication latency for High-Performance Computing (HPC) applications, many systems facilitate the transmission of packets in an unordered manner, leveraging the hashing capabilities of switches within a network fabric to balance the load across multiple paths. However, unordered packet delivery might introduce challenges that can affect reliability. For example, as packets traverse different network paths, varying conditions, such as congestion and intermittent link failures, may increase the likelihood of packet loss. To address this, some systems may employ time out mechanisms or Negative Acknowledgments (NAKs) to detect and re-transmit lost packets. While these systems can ensure eventual delivery, they might introduce significant delays due to the dependence on waiting for timing out or NAKs. To reduce these delays, in a number of embodiments, the packet transmission logic 924 may be provided to optimize the re-transmission of lost packets.

In numerous embodiments, the packet transmission logic 924 may be configured to transmit a set of packets of a flow that has the same EV and unique sequence numbers. Further, the packet transmission logic 924 may be configured to receive an acknowledgment for a delivered packet of the set of packets. In various examples, the received acknowledgment may include the EV and a sequence number of the delivered packet. Furthermore, the packet transmission logic 924 may be configured to detect, based on the EV and the sequence number, whether a packet loss corresponding to the EV has occurred in the flow. In an example, if the packet loss corresponding to the EV has occurred, the packet transmission logic 924 may be configured to re-transmit one or more lost packets without timing-out or receiving a NACK for the lost packets. Accordingly, the packet transmission logic 924 may suppress the dependency on time-outs or NAKs. Therefore, the packet transmission logic 924 may improve job completion times associated with the HPC applications.

In numerous additional embodiments, the EV data 928 may include a plurality of EVs assigned to a plurality of packets of the flow. In various examples, an EV of a packet may correspond to a specific version of a n-tuple combination associated with the packet. In an example, the n-tuple combination may correspond to a 4-tuple combination (e.g., the source and destination IP addresses and the source and destination port numbers) of the packet, a 5-tuple combination (e.g., the source and destination IP addresses, the source and destination port numbers, and the protocol number) of the packet, or the like. In some more examples, the EV may be a specific value that is assigned to the packet based on the n-tuple combination associated with the packet.

In a variety of embodiments, the PSN data 930 may include a plurality of sequence numbers of the plurality of packets. In numerous examples, each sequence number of the plurality of sequence numbers may correspond to a unique identifier assigned to the corresponding packet. In numerous additional examples, the plurality of sequence numbers may be assigned to the plurality of packets in such a way that the plurality of sequence numbers is monotonically increasing. In other words, each packet of the plurality of packets may be assigned with the sequence number in such a way that the assigned sequence number is greater than the sequence number of the previous packet of the plurality of packets.

In various further embodiments, the EV-PSN mapping data 932 may include an mapping database. In many examples, the mapping database may be a tabular database that includes a plurality of rows for the plurality of EVs. In many further examples, each row of the plurality of rows can be configured to store sequence numbers of unacknowledged packets for a respective EV of the plurality of EVs. Further, the sequence numbers can be recorded in an

### Order of Transmission.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

Finally, in numerous additional embodiments, data may be processed into a format usable by a machine-learning model 926 (e.g., feature vectors), and or other pre-processing techniques. The machine-learning (“ML”) model 926 may be any type of ML model, such as supervised models, reinforcement models, or unsupervised models. The ML model 926 may include one or more of linear regression models, logistic regression models, decision trees, Naïve Bayes models, neural networks, k-means cluster models, random forest models, or other types of ML models 926.

The ML model(s) 926 can be configured to generate inferences to make predictions or draw conclusions from data. An inference can be considered the output of a process of applying a model to new data. This can occur by learning from at least the EV data 928, the PSN data 930, and the EV-PSN mapping data 932 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 926 may be generated by human/administrator verifications or may compare predicted outcomes with actual outcomes. Further, the ML model(s) 926 may be utilized to identify one or more unacknowledged packets of the flow by learning the EV data 928, the PSN data 930, and/or the EV-PSN mapping data 932.

Although a specific embodiment for a device 900 suitable for configuration with the packet transmission logic for carrying out the various steps, processes, methods, and operations described herein is discussed with respect to FIG. 9, any of a variety of systems and/or processes may be utilized in accordance with embodiments of the disclosure. For example, the device 900 may correspond to a mobile computing device such as a laptop (or a smartphone), or may correspond to a network device such as an AP. The elements depicted in FIG. 9 may also be interchangeable with other elements of FIGS. 1-8 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A source device, comprising:
a processor; and
a memory communicatively coupled to the processor, wherein the memory comprises a packet transmission logic that is configured to:
transmit a first set of packets of a flow, wherein the first set of packets has a same first Entropy Value (EV) and unique sequence numbers;
receive an acknowledgment including the first EV and a sequence number of a delivered packet of the first set of packets; and
detect, based on the first EV and the sequence number in the acknowledgment, whether a packet loss corresponding to the first EV has occurred in the flow.

2. The source device of claim 1, wherein the packet transmission logic is further configured to transmit a second set of packets of the flow, and wherein the second set of packets has a same second EV and unique sequence numbers.

3. The source device of claim 2, wherein prior to transmitting the first set of packets and the second set of packets, the packet transmission logic is further configured to assign the first EV to the first set of packets and the second EV to the second set of packets.

4. The source device of claim 3, wherein the first EV is assigned to the first set of packets and the second EV is assigned to the second set of packets based on one or more weights associated with the first EV and the second EV.

5. The source device of claim 3, wherein the first EV is assigned to the first set of packets and the second EV is assigned to the second set of packets based on a round-robin scheme.

6. The source device of claim 2, wherein the packet transmission logic is further configured to:
maintain a mapping database for a plurality of EVs including the first EV and the second EV; and
record in the mapping database, in a transmission order of the first set of packets, the unique sequence numbers of the first set of packets in association with the first EV, and in a transmission order of the second set of packets, the unique sequence numbers of the second set of packets in association with the second EV.

7. The source device of claim 6, wherein recording the unique sequence numbers of the first set of packets in the mapping database comprises storing a reduced version of a corresponding unique sequence number in association with the first EV.

8. The source device of claim 6, wherein to detect whether the packet loss has occurred in the flow, the packet transmission logic is further configured to:
perform a look-up in the mapping database based on the first EV and the sequence number of the delivered packet; and
determine, based on the look-up, whether the mapping database indicates presence of one or more unacknowledged packets of the first set of packets that are transmitted prior to the delivered packet.

9. The source device of claim 8, wherein the packet loss is detected in a case where the mapping database indicates the presence of the one or more unacknowledged packets that are transmitted prior to the delivered packet.

10. The source device of claim 9, wherein the packet transmission logic is further configured to re-transmit the one or more unacknowledged packets in a case where the packet loss is detected.

11. The source device of claim 10, wherein the packet transmission logic is further configured to:
remove a set of sequence numbers of the one or more unacknowledged packets from the mapping database based on the re-transmission of the one or more unacknowledged packets; and
record, in a transmission order, a set of new sequence numbers of the re-transmitted one or more unacknowledged packets in the mapping database in association with the first EV.

12. The source device of claim 10, wherein the packet transmission logic is further configured to re-transmit the one or more unacknowledged packets without timing out.

13. The source device of claim 10, wherein the packet transmission logic is further configured to re-transmit the one or more unacknowledged packets, independent of a negative acknowledgment for the one or more unacknowledged packets.

14. The source device of claim 8, wherein the packet loss is detected to be absent in a case where the mapping database indicates absence of the one or more unacknowledged packets of the first set of packets that are transmitted prior to the delivered packet.

15. The source device of claim 6, wherein the packet transmission logic is further configured to remove the sequence number of the delivered packet from the mapping database upon detection of whether the packet loss corresponding to the first EV has occurred in the flow.

16. The source device of claim 1, wherein the first set of packets having the first EV comprises non-consecutive packets of the flow.

17. A source device, comprising:
a processor;
a memory communicatively coupled to the processor; and
a packet transmission logic configured to:
transmit a set of packets of a flow, wherein the set of packets has a same Entropy Value (EV) and unique sequence numbers;
receive an acknowledgment including the EV and a sequence number of a delivered packet of the set of packets;
identify, based on the EV and the sequence number in the acknowledgment, one or more unacknowledged packets in the set of packets that are transmitted prior to the delivered packet; and
re-transmit the identified one or more unacknowledged packets.

18. The source device of claim 17, wherein the packet transmission logic is further configured to re-transmit the one or more unacknowledged packets without timing out or receiving a negative acknowledgment for the one or more unacknowledged packets.

19. A packet transmission method, comprising:
transmitting a set of packets of a flow, wherein the set of packets has a same Entropy Value (EV) and unique sequence numbers;
receiving an acknowledgment including the EV and a sequence number of a delivered packet of the set of packets; and
detecting, based on the EV and the sequence number in the acknowledgment, whether a packet loss corresponding to the EV has occurred.

20. The packet transmission method of claim 19, further comprising re-transmitting one or more packets of the set of packets that are associated with the packet loss, without timing out or receiving a negative acknowledgment for the one or more packets.
